(19) United States
(12) Patent Application Publication
(10) Pub. No.: US 2016/0290025 A1
(43) Pub. Date: Oct. 6, 2016

(54) VEHICLE SLIDING DOOR DEVICE, AND VEHICLE PROVIDED WITH VEHICLE SLIDING DOOR DEVICE

(71) Applicant: MITSUBISHI HEAVY INDUSTRIES, LTD., Minato-ku, Tokyo (JP)

(72) Inventor: Ichiro JOREN, Tokyo (JP)

(73) Assignee: Mitsubishi Heavy Industries, Ltd., Tokyo (JP)

(21) Appl. No.: 15/034,874

(22) PCT Filed: Jul. 11, 2014
(86) PCT No.: PCT/JP2014/068574

§ 371 Date: May 6, 2016

(30) Foreign Application Priority Data
Nov. 14, 2013 (JP) 2013-235901

(51) Int. Cl. E05D 15/06; B61D 19/00; B61D 1/00; E05F 15/00

(52) U.S. Cl. CPC E05D 15/06; E05F 15/00; B61D 19/005; B61D 1/00; E05Y 2900/531

(57) ABSTRACT

Disclosed is a vehicle sliding door device including a sliding door rail formed along a movement direction, and a sliding door including an engagement unit engaged with the sliding door rail, and which is opened and closed when the engagement unit is moved along the sliding door rail. The sliding door rail includes a rattling prevention unit in the region of an end section corresponding to the closed position of the sliding door, in which a gap between the engagement unit of the sliding door and the sliding door rail is narrower than a gap between the engagement unit of the sliding door and the sliding door rail in other regions.

### RELATED APPLICATIONS

The present application is a National Phase entry of International Application No. PCT/JP2014/068574, filed Jul. 11, 2014, which claims priority of Japanese Application No. 2013-235901, filed Nov. 14, 2013.

### TECHNICAL FIELD

The present invention relates to a vehicle sliding door device and a vehicle provided with a vehicle sliding device.

### BACKGROUND ART

A vehicle such as an electric train includes a vehicle sliding door device configured to include a sliding door rail at an entrance of the vehicle, and a sliding door that is moved along the sliding door rail. The vehicle sliding door device opens and closes the entrance of the vehicle by moving the sliding door along the sliding door rail.

Wind pressure during traveling of the vehicle or vibration of the vehicle may cause vibration of the sliding door of such a vehicle sliding door device, and thus, noise may occur. For example, PTL 1 discloses a device in which sliding door holding members are respectively provided in a sliding door and a vehicle configuration member, and which prevents vibration and noise of a sliding door by pressing the sliding door against the vehicle configuration member.

### CITATION LIST

### Patent Literature

[PTL 1] Japanese Unexamined Utility Model Registration Application Publication No. 63-169370

### SUMMARY OF INVENTION

### Technical Problem

In the vehicle sliding door device disclosed in PTL 1, the sliding door holding member provided in the sliding door is required to be brought into contact with the sliding door holding member provided in the vehicle configuration member. For this reason, it is necessary to respectively install the sliding door holding members in the sliding door and the vehicle configuration member in order for the sliding door holding members to be brought into contact with each other. As a result, the structure of the vehicle sliding door device becomes complicated, ease of maintenance is decreased, or the cost is increased, which is a problem.

An object of the present invention is to provide a vehicle sliding door device with a simple structure which is capable of suppressing vibration and noise of a sliding door, and a vehicle provided with the vehicle sliding door device.

### Solution to Problem

According to a first aspect of the invention, in order to achieve this object, there is provided a vehicle sliding door device including: a sliding door rail formed along a movement direction; and a sliding door including an engagement unit engaged with the sliding door rail, and which is opened and closed when the engagement unit is moved along the sliding door rail in the movement direction. The sliding door rail includes a rattling prevention unit in the region of an end portion corresponding to at least one of an open position and a closed position of the sliding door, in which a gap between the engagement unit of the sliding door and the sliding door rail is narrower than that in other regions.

In the vehicle sliding door device, the sliding door rail includes the rattling prevention unit in the vicinity of the end portion corresponding to at least one of the open position and the closed position of the sliding door, in which the gap between the engagement unit of the sliding door and the sliding door rail is narrower than that in the other regions. That is, since it is possible to suppress movement of the sliding door in a width direction of the sliding door rail by decreasing the gap between the sliding door rail and the engagement unit of the sliding door in the vicinity of the end portion of the sliding door rail, it is possible to suppress rattling of the sliding door when the sliding door is present at the open position or the closed position. In addition, it is possible to suppress vibration and noise of the sliding door by providing the rattling prevention unit in only the sliding door rail. As a result, fine adjustment between the sliding door and a vehicle configuration member is not required.

According to a second aspect of the present invention, in the vehicle sliding door device of the first aspect, the rattling prevention unit may be formed in such a way that the gap between the engagement unit of the sliding door and the sliding door rail is gradually decreased from the other regions to the end portion.

As a result, when the sliding door is moved from the other regions to the end portion, the gap between the engagement unit of the sliding door and the sliding door rail is gradually decreased. That is, since it is possible to reduce impact caused by contact between the rattling prevention unit and the engagement unit of the sliding door, compared to an embodiment in which the gap between the engagement unit of the sliding door and the sliding door rail is suddenly decreased, it is possible to smoothly move the sliding door.

According to a third aspect of the present invention, in the vehicle sliding door device of the first or second aspect, the sliding door rail may include a protruding portion having a T-shaped section perpendicular to the movement direction, and extending in the movement direction. The engagement unit of the sliding door may include a recessed portion having a C-shaped section perpendicular to the movement direction, extending in the movement direction, and which is engaged with the protruding portion. The rattling prevention unit may be formed of an enlarged portion protruding from the protruding portion of the sliding door rail to both sides in a width direction of the sliding door rail perpendicular to the movement direction.

Accordingly, the protruding portion of the sliding door rail engaged with the sliding door is interposed in the recessed portion of the engagement unit of the sliding door such that the sliding door rail can be accommodated inside the sliding door. As a result, it is possible to suppress the occupancy range of the sliding door and the sliding door rail of a vehicle to substantially the same range of the thickness dimension (that is, the dimension of the sliding door in the width direction of the sliding door rail) of the sliding door.

According to a fourth aspect of the present invention, in the vehicle sliding door device of the third aspect, the enlarged portion of the rattling prevention unit may be formed in such a way that positions in the movement direction, in which decreasing of the gap between the engagement unit of the sliding door and the sliding door rail is started, are different from each other on both sides in the width direction.

As a result, when the sliding door is moved from the other regions to the end portion, decreasing of the gap between the engagement unit of the sliding door and the sliding door rail on one side (the right side of the sliding door rail in the movement direction) in the width direction of the sliding door rail is started. At this time, the gap between another side (the left side of the sliding door rail in the movement direction) in the width direction of the sliding door rail and the engagement unit of the sliding door can be maintained to be substantially the same gap as when the sliding portion is positioned in the other regions of the sliding door rail. For this reason, impact caused by contact between the rattling prevention unit and the engagement unit of the sliding door occurs on only the one side (for example, the right side of the sliding door rail in the movement direction) in the width direction of the sliding door rail. Impact does not occur on the other side (for example, the left side of the sliding door rail in the movement direction). As a result, it is possible to more smoothly move the sliding door.

The vehicle sliding door device according to each of the aspects, may further include a speed control unit configured to switch the movement speed of the sliding door at a speed switching point such that the movement speed of the sliding door when the sliding door is positioned in the end portion of the sliding door rail is lower than that of the sliding door when the sliding door is positioned in the other regions. The rattling prevention unit may be provided between the speed switching point and the end portion.

Accordingly, it is possible to ensure safety of transportation targets (for example, passengers) of the vehicle during boarding and disembarking by switching the movement speed of the sliding door when the sliding door is moved from the other regions of the sliding door rail to the region of the end portion in which the rattling prevention unit is formed. In addition, it is possible to reduce impact caused by contact between the rattling prevention unit and the engagement unit of the sliding door by reducing the movement speed of the sliding door when the sliding door is positioned in the rattling prevention unit, compared to a case in which the movement speed of the sliding door is unchanged. As a result, it is possible to more smoothly move the sliding door.

A vehicle according to the aspects includes a vehicle body configured to accommodate a transportation target; and the vehicle sliding door device according to any one of the aspects configured to open and close an opening portion which is an entrance of the vehicle body.

Since the vehicle includes the vehicle sliding door device of any one of the aspects, it is possible to suppress vibration of the sliding door caused by wind pressure of during traveling of the vehicle or vibration of the vehicle, and thus, it is possible to suppress the occurrence of noise.

### Advantageous Effects of Invention

In the vehicle sliding door device, and the vehicle provided with the vehicle sliding door device, it is possible to suppress vibration and noise of the sliding door by providing the rattling prevention unit and employing a simple structure.

### BRIEF DESCRIPTION OF DRAWINGS

FIG. 1 is a side view of a vehicle provided with a vehicle sliding door device in a first embodiment of the present invention.

FIG. 2 is a front view of the vehicle sliding door device in the first embodiment of the present invention when seen from the inside of the vehicle.

FIG. 3 is a perspective view illustrating a relationship between a sliding door and a sliding door rail of the vehicle sliding door device in the first embodiment of the present invention.

FIG. 4 is a top view illustrating the relationship between the sliding door and the sliding door rail of the vehicle sliding door device in the first embodiment of the present invention.

FIG. 5 is a top view illustrating the sliding door rail of the vehicle sliding door device in the first embodiment of the present invention.

FIGS. 6A to 6C show enlarged top views illustrating rattling prevention units of the vehicle sliding door devices in the first embodiment and modification examples of the present invention.

FIGS. 7A and 7B show enlarged top views illustrating rattling prevention units of vehicle sliding door devices in a second embodiment and modification examples of the present invention.

FIG. 8 is an enlarged top view illustrating a rattling prevention unit of a vehicle sliding door device in a third embodiment of the present invention.

FIG. 9A shows a view illustrating a sliding door of a vehicle sliding door device, FIG. 9C shows a view illustrating control of the movement speed of the sliding door performed by a speed control unit, and FIG. 9B shows a view illustrating a relationship between the movement speed of the sliding door and a sliding door rail in a fourth embodiment of the present invention.

FIGS. 10A and 10B show top views illustrating a sliding door rail of a vehicle sliding door device in a modification example of each embodiment of the present invention, FIG. 10A is a top view, and FIG. 10B is an enlarged view of a main portion in FIG. 10A.

FIGS. 11A and 11B show enlarged top views illustrating a sliding door rail and a rattling prevention unit of a vehicle sliding door device in a modification example of each embodiment of the present invention, FIG. 11A is a top view, and FIG. 11B is an enlarged view of a main portion in FIG. 11A.

### DESCRIPTION OF EMBODIMENTS

Hereinafter, a vehicle and a (vehicle) sliding door device in various embodiments of the present invention will be described in detail with reference to the accompanying drawings.

### First Embodiment

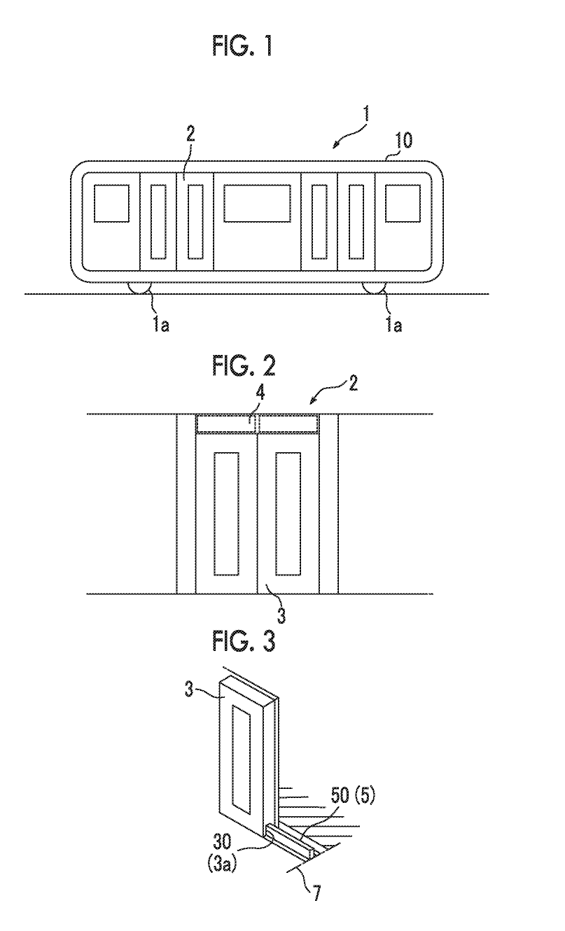

A vehicle 1 and a sliding door device 2 in a first embodiment of the present invention will be described with reference to FIGS. 1 to 5.

As illustrated in FIG. 1, the vehicle 1 in the embodiment includes a vehicle body 10 accommodating transportation targets (for example, passengers) thereinside; a sliding door device 2; and a traveling device 1a traveling the vehicle body 10.

An inner space is formed inside the vehicle body 10, and accommodates the transportation targets. Seats (not illustrated) or straps (not illustrated) are provided in the inner space, and are used by passengers which are transportation targets. A motor or an internal combustion engine is used as the traveling device 1a.

As illustrated in FIGS. 2 to 4, the sliding door device 2 in the embodiment is provided on a side surface of the vehicle body 10, and opens and closes an opening portion of the side surface which is an entrance. The sliding door device 2 includes a sliding door rail 5; a sliding door 3 which is moved along the sliding door rail 5; a door engine 4 moving the sliding door 3 along the sliding door rail 5; and a rattling prevention unit 8 formed in the sliding door rail 5.

The sliding door rail 5 is provided in a lower portion of the sliding door device 2, and includes a protruding portion 50 that extends in a movement direction of the sliding door 3 and protrudes upwards. That is, the sliding door rail 5 is formed to have a T-shaped section in a width direction of the sliding door rail 5. The protruding portion 50 of the sliding door rail 5 is formed to have the same height as that of a floor surface in the inner space of the vehicle body 10 such that the boarding (loading) and disembarking (unloading) of transportation targets are not disturbed.

The sliding door 3 is provided to be opened and closed on the outside of a side surface of the vehicle body 10. An engagement unit 3a is provided in a lower portion of the sliding door 3, and is engaged with the sliding door rail 5. The engagement unit 3a includes a recessed portion 30 that extends along the movement direction of the sliding door 3, and is recessed upwards. That is, the engagement unit 3a is formed to have a C-shaped section in the width direction of the sliding door rail 5. Two sliding doors 3 are configured to be moved on the sliding door rail 5 in different directions such that the opening portion can be opened and closed. The recessed portion 30 of the engagement unit 3a of the sliding door 3 is engaged with the protruding portion 50 of the sliding door rail, and is moves along the protruding portion 50 of the sliding door rail 5.

The door engine 4 is provided in an upper portion of the sliding door device 2, and includes a drive device (not illustrated), which is a drive source for driving the sliding door 3, and a door roller (not illustrated). The drive device is a motor or the like, and is accommodated inside the door engine 4. The door roller is provided in an upper portion of the sliding door 3 such that the sliding door 3 can be slid via the door roller.

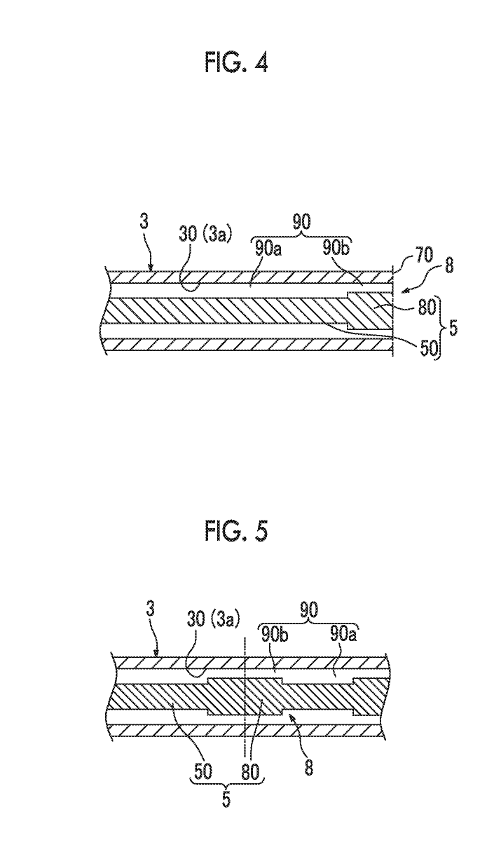

As illustrated in FIGS. 4 and 5, the rattling prevention unit 8 is formed in the sliding door rail 5, and is formed in the region of an end portion (closed-position end portion) 70 of the sliding door rail 5 at a position (closed position) in which the sliding door 3 is closed. The rattling prevention unit 8 is formed in such a way that a gap 90 between the engagement unit 3a of the sliding door 3 and the sliding door rail 5 in the width direction of the sliding door rail 5 is decreased. More specifically, in regions (regions in which the sliding door 3 is engaged with the sliding door rail 5, for example, in a case where the sliding door 3 is present at positions other than the closed position) other than the region of the end portion 70 of the sliding door rail 5, a gap 90a (for example, a gap of 0.75 mm to 2.75 mm) is formed to the extent that the sliding door 3 can be smoothly moved. In contrast, a gap 90b (for example, a gap of 0 mm to 2 mm) narrower than the gap 90a is formed in the region of the end portion of the sliding door rail 5.

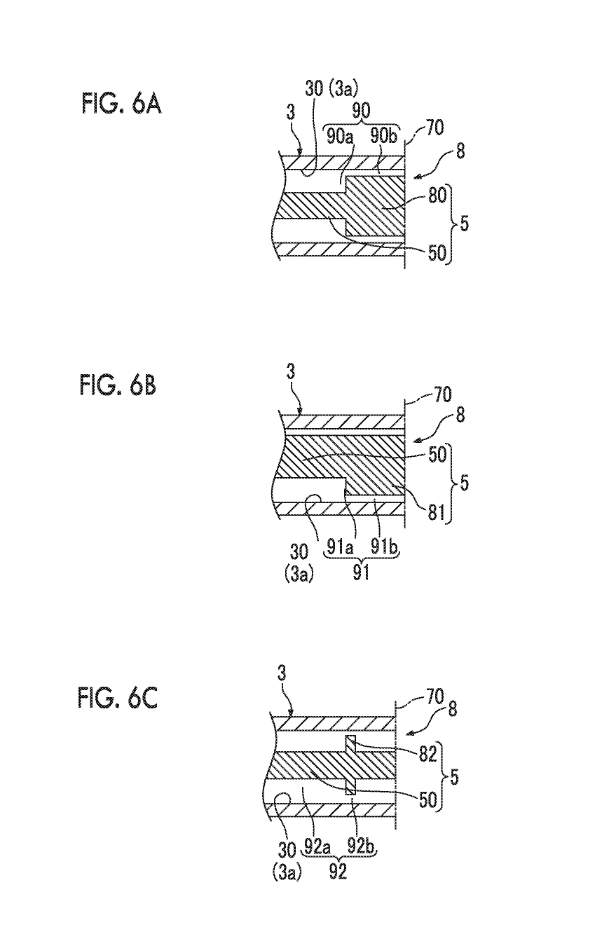

As illustrated in FIG. 6A, the rattling prevention unit 8 is formed of an enlarged portion 80 that protrudes to both sides in the width direction of the sliding door rail 5 in the region of the end portion 70 of the sliding door rail 5. That is, the width of the rattling prevention unit 8, which is formed as the enlarged portion 80 in the region of the end portion 70 of the sliding door rail 5, is set to be greater than that of the protruding portion 50 in the regions other than the region of the end portion 70 of the sliding door rail 5.

In addition, as illustrated in FIG. 6B, the rattling prevention unit 8 may be formed of an enlarged portion 81 that protrudes to only one side in the width direction of the sliding door rail 5 in the region of the end portion 70 of the sliding door rail 5.

As illustrated in FIG. 6C, the rattling prevention unit 8 is not necessarily formed in the end portion 70 of the sliding door rail 5, and may be formed in the vicinity region of the end portion 70.

As described above, in the sliding door device 2 of the embodiment, the enlarged portion 80 protruding to both sides in the width direction of the sliding door rail 5 is formed as the rattling prevention unit 8 in the region of the end portion 70 of the sliding door rail 5. That is, since the gap between the engagement unit 3a of the sliding door 3 and the sliding door rail 5 in the width direction of the sliding door rail 5 is narrower than that in the other regions, in a case where the sliding door 3 is present at the closed position, movement of the sliding door 3 in the width direction (direction perpendicular to a travel direction of the vehicle) of the sliding door rail 5 is limited. For this reason, it is possible to suppress vibration of the sliding door 3 caused by wind pressure during traveling of the vehicle 1, or vibration of the vehicle 1, and to suppress noise caused by vibration of the sliding door 3.

### Second Embodiment

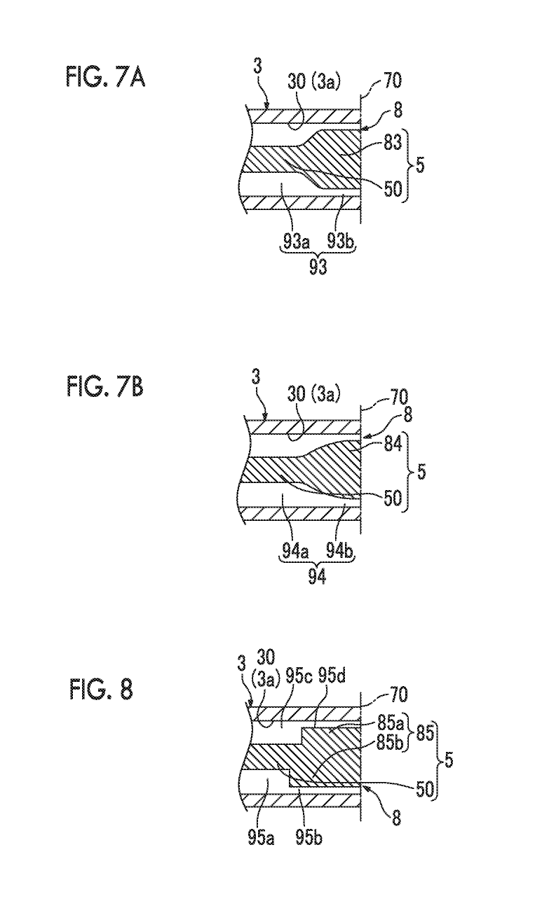

The vehicle 1 and the sliding door device 2 in a second embodiment of the present invention will be described with reference to FIGS. 7A and 7B.

The shape of the rattling prevention unit 8 in the second embodiment is different from that of the rattling prevention unit 8 in the first embodiment.

As illustrated in FIGS. 7A and 7B, the rattling prevention unit 8 in the embodiment is formed in such a way that a gap between the engagement unit 3a of the sliding door 3 and the sliding door rail 5 in the width direction of the sliding door rail 5 is gradually decreased from the regions other than the region of the end portion 70 of the sliding door rail 5 to the region of the end portion 70. More specifically, the rattling prevention unit 8 is formed of an enlarged portion 83 or 84, both sides of which protrude in such a way as to be gradually increased in the width direction of the sliding door rail 5 from the regions other than the region of the end portion 70 of the sliding door rail 5 to the region of the end portion 70. In the rattling prevention unit 8 of the embodiment, as illustrated in FIG. 7A, the width of the sliding door rail 5 may be increased in such a way that the enlarged portion 83 is formed into a straight shape, and as illustrated in FIG. 7B, the width of the sliding door rail 5 may be increased in such a way that the enlarged portion 84 is formed into a curved shape.

As described above, in the sliding door rail 5 of the sliding door device 2 of the second embodiment, the rattling prevention unit 8 is formed in such a way that a gap 93 or 94 between the engagement unit 3a of the sliding door 3 and the sliding door rail 5 is gradually decreased when the sliding door 3 is moved from the other regions to the region of the end portion 70. That is, since it is possible to reduce impact caused by contact between the rattling prevention unit 8 and the engagement unit 3a of the sliding door 3, compared to the first embodiment in which the gap 90 between the engagement unit 3a of the sliding door 3 and the sliding door rail 5 is suddenly decreased, it is possible to smoothly move the sliding door 3.

### Third Embodiment

The vehicle 1 and the sliding door device 2 in a third embodiment of the present invention will be described with reference to FIG. 8.

The third embodiment is different from the first embodiment in that the rattling prevention unit 8 is formed of an enlarged portion 85, both sides of which are differently formed in the width direction of the sliding door rail 5.

As illustrated in FIG. 8, the enlarged portion 85 is formed as the rattling prevention unit 8 in the embodiment in the region of the end portion 70 of the sliding door rail 5, and includes a first enlarged portion 85a and a second enlarged portion 85b which are respectively formed on the both sides in the width direction of the sliding door rail 5. The first enlarged portion 85a and the second enlarged portion 85b are formed in such a way that positions in the movement direction, in which decreasing of a gap 95 between the engagement unit 3a of the sliding door 3 and the sliding door rail 5 is started, are different from each other on the both sides in the width direction of the sliding door rail 5. More specifically, the first enlarged portion 85a is positioned close to the regions other than the region of the end portion 70 of the sliding door rail 5, compared to the second enlarged portion 85b.

As described above, since the rattling prevention unit 8 of the sliding door device 2 in the third embodiment is formed of the enlarged portion 85 in which the positions, in which decreasing of the gap 95 between the engagement unit 3a of the sliding door 3 and the sliding door rail 5 is started, are different from each other on the both sides in the width direction of the sliding door rail 5 (a boundary position between a gap 95a and a gap 95b is different from that between a gap 95c and a gap 95d in the movement direction of the sliding door 3), when the sliding door 3 is moved from the other portions to the end portion 70, decreasing of the gap 95 between the engagement unit 3a of the sliding door 3 and the sliding door rail 5 on one side (the right side (side on which the second enlarged portion 85b is formed in FIG. 8) of the sliding door rail 5 toward the end portion 70 in the movement direction) in the width direction of the sliding door rail 5 is started. At this time, the gap between another side (the left side (side on which the first enlarged portion 85a is formed in FIG. 8) of the sliding door rail 5 toward the end portion 70 in the movement direction) in the width direction of the sliding door rail 5 and the engagement unit 3a of the sliding door 3 can be maintained to be substantially the same gap 95c of when the sliding door 3 is positioned in the other regions of the sliding door rail 5. For this reason, impact caused by contact between the rattling prevention unit 8 and the engagement unit 3a of the sliding door 3 occurs on only the one side (for example, the side on which the second enlarged portion 85b is formed) in the width direction of the sliding door rail 5, and impact does not occur on the other side (for example, the side on which the first enlarged portion 85a is formed). As a result, it is possible to smoothly move the sliding door 3, compared to the sliding door device 2 in the first embodiment.

### Fourth Embodiment

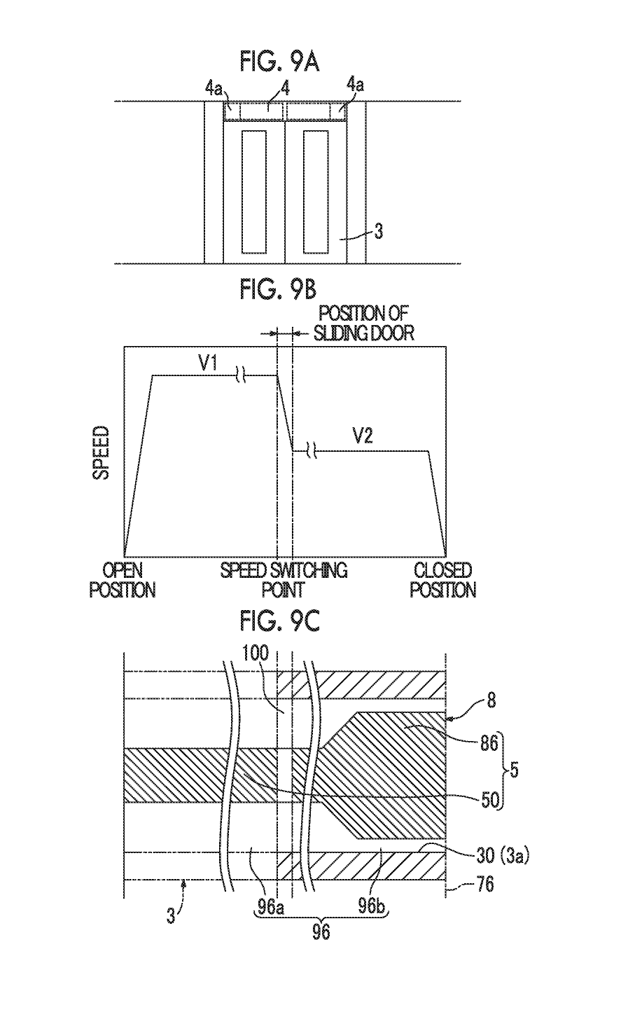

The vehicle 1 and the sliding door device 2 in a fourth embodiment of the present invention will be described with reference to FIGS. 9A to 9C.

In the fourth embodiment, as illustrated in FIG. 9A, the sliding door device 2 includes a speed control unit 4a that is provided in the door engine 4, and is capable of switching the movement speed of the sliding door 3 when the sliding door 3 is moved from an open position to the closed position. The fourth embodiment is different from the first embodiment in that the rattling prevention unit 8 is provided between a position, in which the movement speed of the sliding door 3 is switched, and the end portion 70 of the sliding door rail 5 corresponding to the closed position of the sliding door 3.

As illustrated in FIG. 9B, the door engine 4 in the embodiment is capable of switching the movement speed of the sliding door 3 via the speed control unit 4a when the sliding door 3 is moved from the open position to the closed position.

More specifically, when the sliding door 3 is moved from the open position to the closed position, the sliding door 3 is moved between the open position and a speed switching point 100 at movement speed V1, and thereafter, the sliding door 3 is moved between the speed switching point 100 and the closed position at movement speed V2 lower than movement speed V1. The speed switching point 100 is not necessarily a single point in the movement direction, and may have a predetermined range (for example, the range surrounded by the chain line in FIG. 9B). The door engine 4 may be able to switch the movement speed between two or more movement speeds (for example, V1, V2, V3, . . . Vn). In this case, a movement speed (Vn) of when the sliding door 3 is moved to the closed position after passing a speed switching point closest to the closed position is set to be lower than a movement speed (Vn−1) of before the sliding door passes the speed switching point.

As illustrated in FIG. 9C, the rattling prevention unit 8 in the embodiment is provided between the speed switching point 100 and the end portion 70 of the sliding door rail 5 corresponding to the closed position of the sliding door 3. That is, an enlarged portion 86 is formed as the rattling prevention unit 8 between the speed switching point 100 and the end portion 70 of the sliding door rail 5 corresponding to the closed position of the sliding door 3. The enlarged portion 86 protrudes to both sides in the width direction of the sliding door rail 5. The enlarged portion 86 have the same shape as that of the enlarged portion 83, but may have the same shape as that of any one of the enlarged portions 80, 81, 82, 84, and 85.

As described above, the sliding door device 2 in the fourth embodiment is capable of ensuring safety of transportation targets (for example, passengers) of the vehicle 1 during boarding and disembarking by switching the movement speed of the sliding door 3 when the sliding door 3 is moved from other regions of the sliding door rail 5 to the region of the end portion 70 in which the rattling prevention unit 8 is formed. In addition, it is possible to reduce impact, which is caused by contact between the rattling prevention unit 8 and the sliding door 3, applied to the transportation targets and the sliding door 3. For this reason, it is possible to ensure the safety of the transportation targets, and to prevent the occurrence of a failure of the sliding door device 2 caused by contact between the engagement unit 3a of the sliding door 3 and the sliding door rail 5. Since it is possible to reduce impact caused by contact between the rattling prevention unit 8 and the engagement unit 3a of the sliding door 3 by reducing the movement speed of the sliding door 3 when the sliding door 3 comes into contact with the rattling prevention unit 8, compared to the other embodiments in which the movement speed of the sliding door 3 is unchanged, it is possible to more smoothly move the sliding door 3.

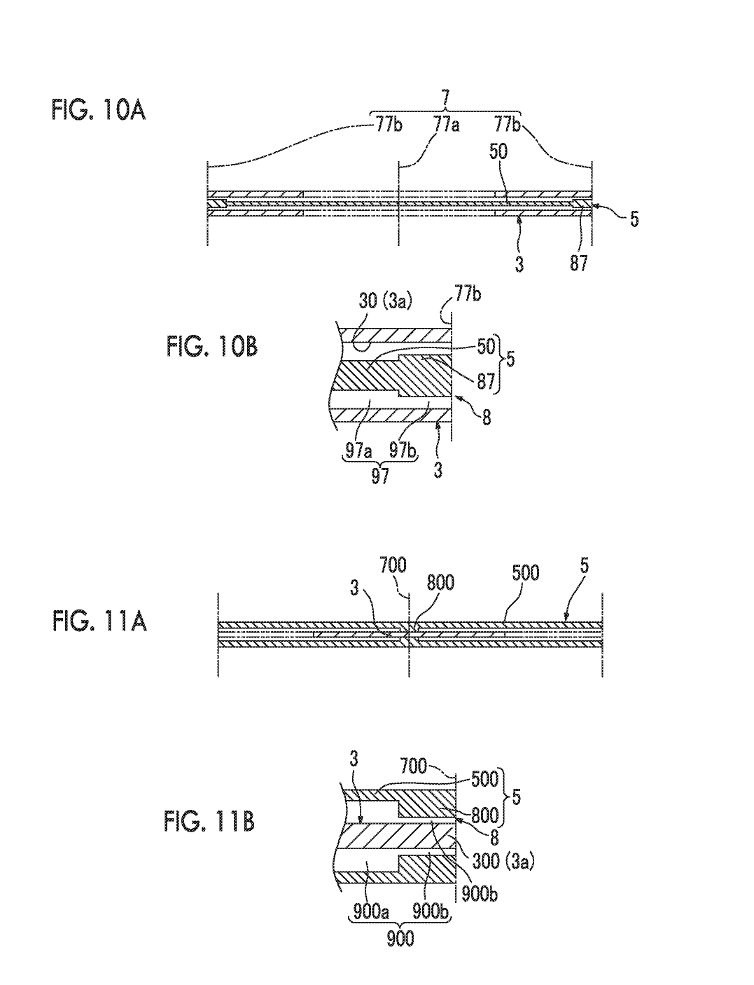

The embodiments of the present invention have been described; however, the present invention is not limited to the embodiments. As illustrated in FIGS. 10A and 10B, the rattling prevention unit 8 may be formed in the region of an end portion (open-position end portion) 77b of the sliding door rail 5 at a position (open position) in which the sliding door 3 is open. In this case, in the region of the end portion 77b of the sliding door rail 5 of the sliding door device 2, a gap 97b (97) between the engagement unit 3a of the sliding door 3 and the sliding door rail 5 in the width direction of the sliding door rail 5 is narrower than a gap 97a (97) in other regions. For this reason, in a case where the sliding door 3 is present at the open position, movement of the sliding door 3 in the width direction (direction perpendicular to the travel direction of the vehicle 1) of the sliding door rail 5 is limited. As a result, it is possible to suppress vibration of the sliding door 3 caused by wind pressure of during stop of the vehicle 1, or vibration of the vehicle 1, and to suppress noise caused by vibration of the sliding door 3.

The rattling prevention units 8 may be respectively formed in the region of a closed-position end portion 77a and the regions of the open-position end portions 77b. In this case, it is possible to suppress vibration of the sliding door 3 caused by wind pressure of during traveling of the vehicle 1 and stop of the vehicle 1, or vibration of the vehicle 1, and to suppress noise caused by vibration of the sliding door 3.

As illustrated in FIGS. 11A and 11B, the sliding door rail 5 may include a recessed portion 500, and the engagement unit 3a of the sliding door 3 may include a protruding portion 300. In this case, the recessed portion 500 of the sliding door rail 5 is engaged with the protruding portion 300 of the engagement unit 3a of the sliding door 3, and the sliding door 3 is moved along the recessed portion 500 of the sliding door rail 5. In this case, the rattling prevention unit 8 is formed in the sliding door rail 5, and is formed in the region of an end portion 700 of the sliding door rail 5 at a position (closed position) in which the sliding door 3 is closed. In the rattling prevention unit 8, a gap 900b (900) between the engagement unit 3a of the sliding door 3 and the sliding door rail 5 in the width direction of the sliding door rail 5 is narrower than a gap 900a (900) in other regions of the sliding door rail 5.

As illustrated in FIGS. 11A and 11B, the sliding door 3 and the sliding door rail 5 may be provided in such a way that the recessed portion 500 and the protruding portion 300 are not provided, and a lower portion of the sliding door 3 is interposed between a pair of the sliding door rails 5 on both sides in the width direction.

The sliding door rail 5 without the rattling prevention unit 8, and the rattling prevention unit 8 may be formed as separate members. Accordingly, it is possible to install the rattling prevention unit 8 after constructing the sliding door rail 5 made of a rectangular member having a uniform section, it is possible to easily construct the sliding door rail 5 and the rattling prevention unit 8. Since fine adjustment of the installation position of the rattling prevention unit 8 becomes easy, it is possible to dispose the rattling prevention unit 8 at the best optimal position according to specifications of the vehicle 1 or the sliding door device 2.

Alternatively, the sliding door rail 5 may be formed in such a way that the sliding door rail 5 is divided into a portion not including the rattling prevention unit 8 and a portion including the rattling prevention unit 8.

A combination of the embodiments may be adopted.

### INDUSTRIAL APPLICABILITY

The vehicle sliding door device of the present invention can be applied to a vehicle or the like. In the vehicle sliding door device with a simple structure of the present invention, vibration and noise of a sliding door can be suppressed by a rattling prevention unit.

1. A vehicle sliding door device comprising:
a sliding door rail formed along a movement direction; and
a sliding door including an engagement unit engaged with the sliding door rail, and which is opened and closed when the engagement unit is moved along the sliding door rail in the movement direction,
wherein the sliding door rail includes a rattling prevention unit in the region of an end portion corresponding to at least one of an open position and a closed position of the sliding door, in which a gap between the engagement unit of the sliding door and the sliding door rail is narrower than that in other regions; and
a protruding portion having a T-shaped section perpendicular to the movement direction, and extending in the movement direction,
wherein the engagement unit of the sliding door includes a recessed portion having a C-shaped section perpendicular to the movement direction, extending in the movement direction, and which is engaged with the protruding portion,
wherein the rattling prevention unit is formed of an enlarged portion protruding from the protruding portion of the sliding door rail to both sides in a width direction of the sliding door rail perpendicular to the movement direction, and
wherein the enlarged portion is formed in such a way that positions in the movement direction, in which decreasing of the gap between the engagement unit of the sliding door and the sliding door rail is started, are different from each other on both sides in the width direction.

2. The vehicle sliding door device according to claim 1,
wherein the rattling prevention unit is formed in such a way that the gap between the engagement unit of the sliding door and the sliding door rail is gradually decreased from the other regions to the end portion.

3. (canceled)

4. (canceled)

5. The vehicle sliding door device according to claim 1, further comprising:
a speed control unit configured to switch the movement speed of the sliding door at a speed switching point such that the movement speed of the sliding door when the sliding door is positioned in the end portion of the sliding door rail is lower than that of the sliding door when the sliding door is positioned in the other regions, and
wherein the rattling prevention unit is provided between the speed switching point and the end portion.

6. A vehicle comprising:
a vehicle body configured to accommodate a transportation target; and
the vehicle sliding door device according to claim 1 configured to open and close an opening portion which is an entrance of the vehicle body.
